(19) United States
(12) Patent Application Publication
(10) Pub. No.: US 2019/0199626 A1
(43) Pub. Date: Jun. 27, 2019

(54) ROUTING TRAFFIC ACROSS ISOLATION NETWORKS

(71) Applicant: Cisco Technology, Inc., San Jose, CA (US)

(72) Inventors: Pascal Thubert, La Colle Sur Loup (FR); Eric Levy-Abegnoli, Valbonne (FR); Jean-Philippe Vasseur, Saint Martin D'uriage (FR); Patrick Wetterwald, Mouans Sartoux (FR)

(21) Appl. No.: 15/854,040

(22) Filed: Dec. 26, 2017

(51) Int. Cl. H04L 12/715; H04L 12/801; H04L 12/709

(52) U.S. Cl. CPC H04L 45/64; H04L 45/245; H04L 47/19

(57) ABSTRACT

In one embodiment, a cloud-based service instructs one or more networking devices in a local area network (LAN) to form a virtual network overlay in the LAN that redirects traffic associated with a particular node in the LAN to a first isolation application instance hosted by the service. The first isolation application instance receives the redirected traffic associated with the particular node. The first isolation application instance determines a routing path for the traffic that comprises one or more other isolation application instances hosted by the cloud-based service. The first isolation application instance tags the traffic to indicate the determined routing path. The first isolation application forwards the tagged traffic to a second isolation application instance along the determined routing path.

### TECHNICAL FIELD

The present disclosure relates generally to computer networks, and, more particularly, to applying services using isolation networks.

### BACKGROUND

A new form of network attack is now taking shape, whereby the Internet of Things (IoT) is used to attack the rest of the world, as opposed to the other way around. For example, a recent distributed denial of service (DDoS) attack exceeded 620 Gbps of brute force login attacks, nearly doubling that of previous peak attacks. While this was one of the largest attacks recorded to date, there are additional factors that set it apart from a “standard DDoS.” Most significantly, the attack was generated by a BotNet that was comprised primarily of IoT devices. The majority of these devices were identified as security cameras and digital video records (DVRs) that were used in “Small Office/Home Office” (SoHo) setups. Of particular interest is that the attack included a substantial amount of traffic connecting directly from the BotNet to the target, rather than reflected and/or amplified traffic, as seen in recent large attacks using Network Time Protocol (NTP) and Domain Name System (DNS) vulnerabilities.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIGS. 3A-3C illustrate an example of isolation network formation;

FIG. 4 illustrates an example of using isolation application instances to implement a control loop;

FIG. 5A-5C illustrates an example of using a device database to control routing paths between isolation application instances;

FIG. 6 illustrates an example of applying chained micro-services to traffic;

FIG. 7A-7E illustrates an example of forwarding traffic between micro-services associated with different isolation application instances;

FIG. 8 illustrates an example directed acyclic graph (DAG) between isolation application instances; and

FIG. 9 illustrates an example simplified procedure for forwarding traffic between isolation application instances.

### DESCRIPTION OF EXAMPLE EMBODIMENTS

### Overview

According to one or more embodiments of the disclosure, a cloud-based service instructs one or more networking devices in a local area network (LAN) to form a virtual network overlay in the LAN that redirects traffic associated with a particular node in the LAN to a first isolation application instance hosted by the service. The first isolation application instance receives the redirected traffic associated with the particular node. The first isolation application instance determines a routing path for the traffic that comprises one or more other isolation application instances hosted by the cloud-based service. The first isolation application instance tags the traffic to indicate the determined routing path. The first isolation application forwards the tagged traffic to a second isolation application instance along the determined routing path.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or powerline networks. That is, in addition to one or more sensors, each sensor device (node) in a sensor network may generally be equipped with a radio transceiver or other communication port such as powerline communication ports, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

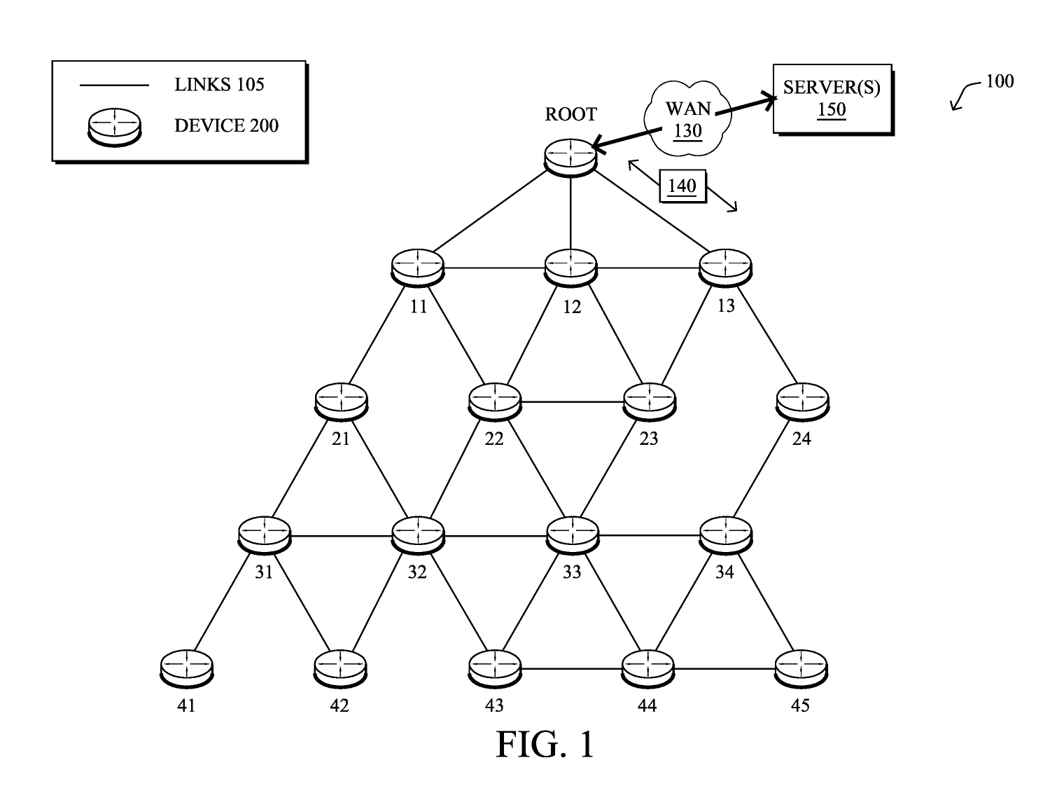

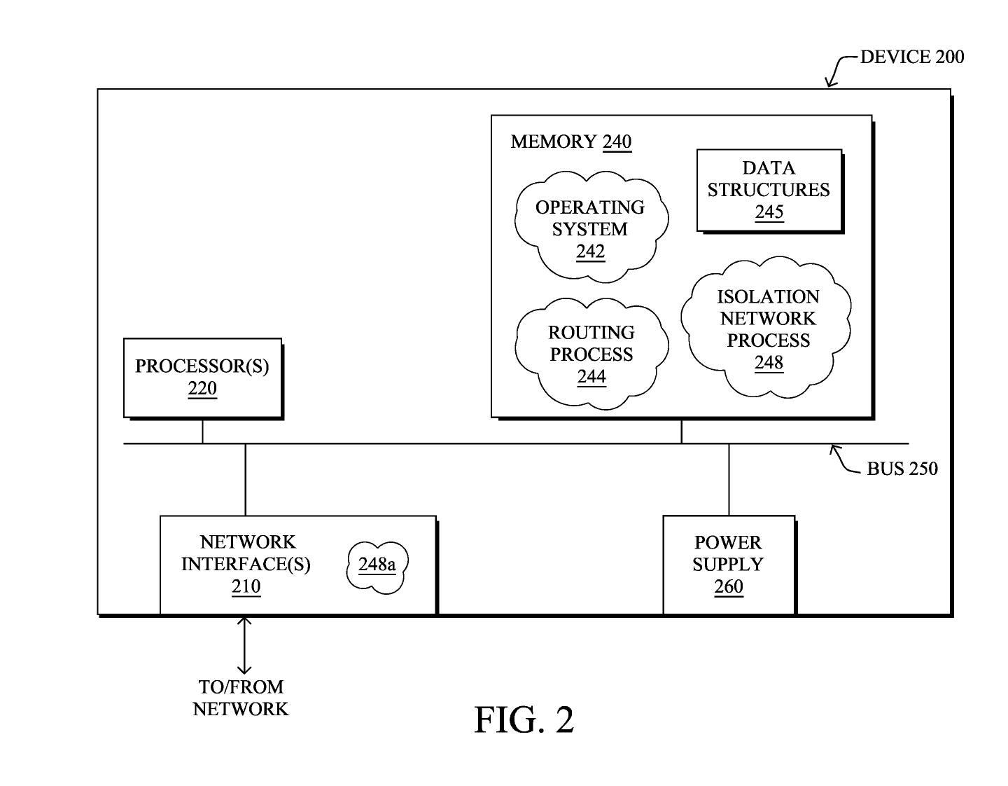

FIG. 1 is a schematic block diagram of an example computer network 100 illustratively comprising nodes/devices 200 (e.g., labeled as shown, “root,” “11,” “12,” . . . “45,” and described in FIG. 2 below) interconnected by various methods of communication. For instance, the links 105 may be wired links or shared media (e.g., wireless links, powerline links, etc.) where certain nodes 200, such as, e.g., routers, sensors, computers, etc., may be in communication with other nodes 200, e.g., based on distance, signal strength, current operational status, location, etc. The illustrative root node, such as a field area router (FAR), may interconnect the local networks with WAN 130, which may house one or more other relevant devices such as management devices or servers 150, e.g., a network management server (NMS), a dynamic host configuration protocol (DHCP) server, a constrained application protocol (CoAP) server, an outage management system (OMS), etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages) may be exchanged among the nodes/devices of the computer network 100 using predefined network communication protocols such as certain known wired protocols, wireless protocols (e.g., IEEE Std. 802.15.4, WiFi, Bluetooth®, etc.), powerline communication protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes or devices shown in FIG. 1 above. The device may comprise one or more network interfaces 210 (e.g., wired, wireless, powerline, etc.), at least one processor 220, and a memory 240 interconnected by a system bus 250, as well as a power supply 260 (e.g., battery, plug-in, etc.).

The network interface(s) 210 include the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for powerline communications, the network interface 210 may communicate through the power supply 260, or may be an integral component of the power supply. In some specific configurations the powerline signal may be coupled to the powerline feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. Operating system 242, portions of which is typically resident in memory 240 and executed by the processor, functionally organizes the device by, inter alia, invoking operations in support of software processes and/or services executing on the device. These software processes and/or services may comprise routing process/services 244, an illustrative isolation network process 248, and an illustrative device configuring process 249, as described herein. Note that while process 248 and process 249 are shown in centralized memory 240, alternative embodiments provide for the process to be specifically operated within the network interfaces 210, such as a component of a MAC layer (e.g., process 248a).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 includes computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) including, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

As described in greater detail below, isolation network process 248 may be configured to form an “isolation network” that isolates a given network node from a networking perspective and cause the traffic of the node to be rerouted for analysis (e.g., by process 248). In some cases, isolation network process 248 may use the rerouted traffic to train a machine learning-based behavioral model of the node. In general, machine learning is concerned with the design and the development of techniques that receive empirical data as input (e.g., data regarding the performance/characteristics of the network) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a, b, and c such that the number of misclassified points is minimal. After this optimization/learning phase, experience prediction process 248 can use the model M to classify new data points, such as a new traffic flow associated with the node. Often, M is a statistical model, and the cost function is inversely proportional to the likelihood of M, given the input data.

In various embodiments, isolation network process 248 may employ one or more supervised, unsupervised, or semi-supervised machine learning models to analyze traffic flow data. Generally, supervised learning entails the use of a training dataset, which is used to train the model to apply labels to the input data. For example, the training data may include sample traffic flows that are deemed “suspicious,” or “benign.” On the other end of the spectrum are unsupervised techniques that do not require a training set of labels. Notably, while a supervised learning model may look for previously seen network data that has been labeled accordingly, an unsupervised model may instead look to whether there are sudden changes in the behavior of the node (e.g., the node suddenly starts attempting a large number of connections to a previously unseen destination, etc.). Semi-supervised learning models take a middle ground approach that uses a greatly reduced set of labeled training data.

Example machine learning techniques that isolation network process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

Security is one of the prime topics of concern for the IoT, and it could become a roadblock for massive adoption if it is not properly addressed. Until now, there were very few attacks which targeted the IoT space, and IoT solutions for security are in fact very minimal (for the most part they are extensions of firewalls with smart device signatures). Not only could the IoT attacks ramp up massively as IoT is being deployed, but their scale could be unprecedented due to the pervasive nature of the deployment, and their complexity could become overwhelming considering the number of protocols involved.

As noted above, a new form of IoT attack is now taking shape, whereby the IoT is used to attack the rest of the world, as opposed to the other way around. For example, a recent distributed denial of service (DDoS) attack exceeded 620 Gbps of brute force login attacks, nearly doubling that of previous peak attacks. While this was one of the largest attacks recorded to date, there are additional factors that set it apart from a “standard DDoS.” Most significantly, the attack was generated by a BotNet that was comprised primarily of “Internet of Things” (IoT) devices. The majority of these devices were identified as security cameras and DVRs that were used in “Small Office/Home Office” (SoHo) setups. Of particular interest is that the attack included a substantial amount of traffic connecting directly from the BotNet to the target, rather than reflected and/or amplified traffic, as seen in recent large attacks using NTP and DNS vulnerabilities.

It is worth noting that this example attack was a DDoS attack, whereas a wide range of highly concerning attacks target data leaking or extraction, exposing private data and confidential information with possibly dramatic consequences.

The BotNet in the example above lived on the discrepancy between end-user expectations (e.g., a plug-and-play device) and the actual system they deploy (e.g., a Unix computer connected to the Internet).

The Internet is facing a widespread problem that lowers user's confidence in IoT, such as where people suddenly discover that anyone can actually see into their home through that very camera they installed for their “protection”, without proper security measures and configuration taking place. Effectively, the inside of thousands of homes may be exposed over the Internet, and the next step for burglars could be to effectively use a recommendations engine to select the best house for tonight's robbery.

Notably, certain systems (e.g., a Unix system as designed for a PC or a server) comes with the capability to connect anywhere in the Internet over all sorts of protocols (SSH, HTTP, etc.) in a fashion that looks actually legit in the wire. These systems, in particular, often have the capability to open ports in the firewall (STUN, TURN, ICE . . . ), and place severe requirements on the end user, such as forcing frequent updates to cope with newly found vulnerabilities, and requiring login management to prevent unwanted parties from accessing the system.

The user expectation is that it an IoT device is plug-and-play and largely unmanaged. People do not know or care what a root user is and cannot imagine that their camera can dig gaping holes in their trusted firewall. People also will not think of or know how to upgrade their IoT systems. In fact, upgrades may not even be available from some vendors, which may either have disappeared from the market or may have rapidly lost interest in older systems in order to focus on producing new ones. Furthermore, the sheer volume of IoT devices implies a very quick and easy installation process, commonly at the expense of weaker security (e.g., shared secret, PSK). A number of examples of such trade-offs is already commercially distributed, and involves both consumer and professional grade equipment. The average IoT device often comes out-of-the-box with a well-known root password that will never be changed (such as “admin/admin”), is reachable at an easily guessable IP address (e.g., in the 192.168.1.0/24 range) and is loaded with vulnerabilities that are fully documented in the dark web and will never be fixed. Basically, many IoT devices are open doors for hackers over the Internet, and are much easier to compromise than a classical PC.

At this time, there are so many IoT devices that can be easily compromised that the attacker does not care whether a particular compromised device is detected. There needs to be no anonymity network (e.g., Tor Project), no redirection complexity, no weird packet construction that can be used to recognize a fraud. The attack comes straight from apparently a plain user, using direct connectivity such as GRE tunnels, for which defenses are not really prepared, and which may be a lot harder to sort out from real traffic.

Thus, an untrusted node may be applied in situations where a user has a limited a-priori understanding of the security posture of the device (e.g., vulnerabilities and credentials) and of its behavior, such as, e.g., opening ports for network address translation (NAT) using Universal Plug and Play (UPnP). Furthermore, a user may have no control on the device software, as originally coming out of the box and then also through firmware updates.

An attack on an IoT device may leak private information to the internet, open the private network to attackers, as well as enable an incredibly powerful BotNet. While BotNets may target the higher end of the IoT, such as TVs with hardware for video communication, video surveillance, and baby monitors, Trojan attacks may leverage any device, including bathroom scales, medical care objects, remote controls, etc. to turn the firewall and open NAT ports. Anything connected can become a backdoor to the whole private network.

Isolation Networks for Computer Devices

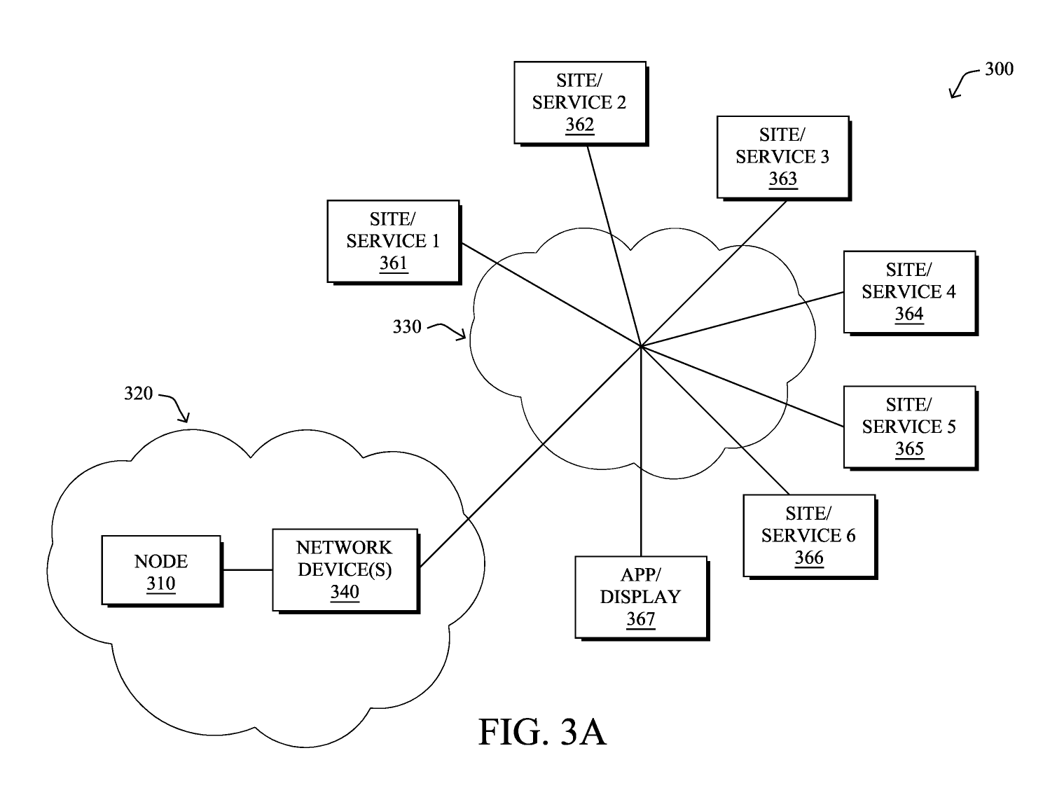

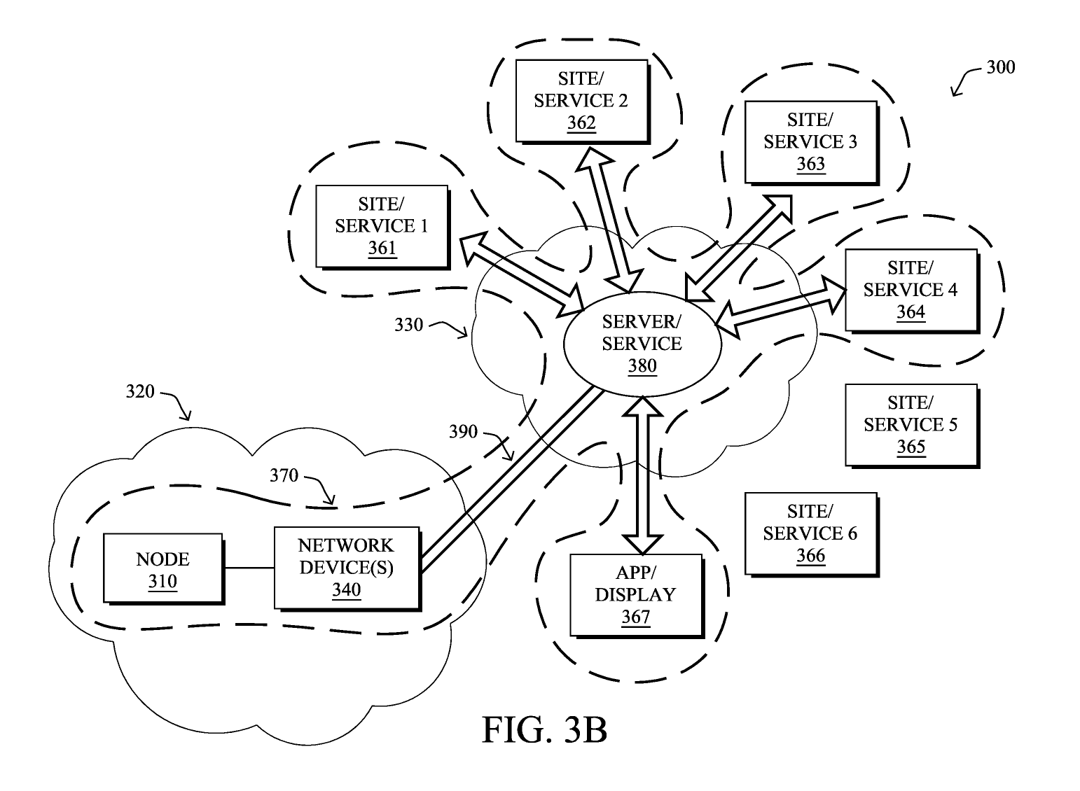

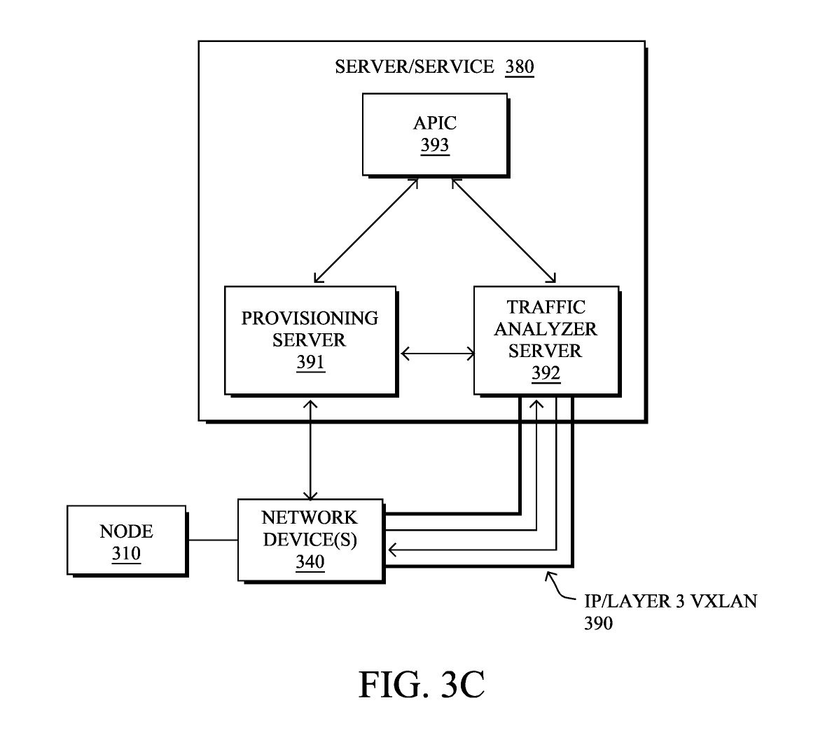

Operationally, FIGS. 3A-3C illustrate an example formation of the overall architecture discussed herein. As shown in FIG. 3A, network 300 comprises an IoT device in a network connecting to various sites, services, and/or applications. In particular, node 310 (e.g., a home or building device including a security camera, a video/audio recording device, a thermostat, a kitchen appliance, a bathroom scale, etc.) in local area network (LAN) 320 (e.g., a home or SoHo LAN or WLAN) may connect to one or more remote destinations outside of LAN 320 (e.g., site/service 1-site/service 6, 361-366, and application/display 367), such as through external network 330 (e.g. a WAN). As shown, node 310 may communicate via one or more networking devices 340 of LAN 320 (e.g., wired or wirelessly) to access the various destination 361-367 and/or other destination nodes within LAN 320. As would be appreciated, networking device(s) 340 may include, but are not limited to, (wireless) access points (APs), switches, routers, a gateway that connects LAN 320 to external network 330, combinations thereof, and the like. In general, node 310 may be able to access a wide variety of different sites and services, some of which may be either unneeded or potentially harmful or dangerous to the device as well as to other devices within its local network. As discussed above, securing the devices within LAN 320, particularly node 310, from attack may become increasingly challenging with such unchecked accesses.

FIG. 3B illustrates a specific embodiment of the present disclosure in which an isolation network is formed in order to provide improved security for node 310. As shown, a server/service 380 in external network 330 may cause the formation of a virtual network overlay that acts as an isolation network 370 for node 310. In the case of cloud-computing environments, multiple devices may be used to provide service 380. In such cases, the term “server” refers to the collective devices operating in conjunction with one another. Isolation network 370 may, in some embodiments, include node 310, the one or more networking devices 340 of LAN 320, as well as one or more destinations with which node 310 is authorized to communicate. For example, sites/services 365-366 are outside of isolation network 370 and, thus, traffic from node 310 to these sites/services would be blocked.

In more detail, in some embodiments, server/service 380 may instruct networking device(s) 340 to bridge/tunnel traffic associated with node 310 to server/service 380 for further analysis. For example, rather than sending a request from node 310 to site/service 361, the gateway of LAN 320 may redirect the traffic via a tunnel to server/service 380 for further analysis. Server 380 could also re-inject the traffic received from node 310 via the networking device(s) 340 back towards the networking device(s), to let it be bridged or routed as initially intended. When doing so, it could provide detailed instructions, embedded into the tunnel header, to instruct the networking device(s) 340 (e.g., a bridge or router), to restrict the way traffic should be bridged or routed.

As an example, assuming the networking device 340 is a switch, it may receive a multicast packet such as a Router Solicit (RS). Normally, the switch would simply broadcast to all nodes. Instead, the RS may be sent to the server 380, server 380 may decide that it should only go to the routers, re-inject the received packet to the switch, but instruct it about the 2 nodes. In turn, when the switch receives the packet, instead of broadcasting, it may only replicate the packet to the two routers.

As part of the formation of isolation network 370, server/service 380 may also generate a unique identifier for the virtual overlay of isolation network 370. For example, server/service 380 may generate and send a unique service set identifier (SSID) to networking device(s) 340, which node 310 can then use to access LAN 320 wirelessly (e.g., via a wireless AP). Similarly, for wired communication (e.g., IEEE Std. 802.15.4), the identifier may be a PAN-ID. When node 310 attempts to communicate outside of LAN 320, a communication may be received at server/service 380 via the virtual overlay of isolation network 370, and a determination may be made by the device whether the destination of the communication is one of the authorized destinations that are within the virtual overlay. The communication may then be sent to the destination if it is determined that it is, in fact, an authorized destination.

As a specific embodiment of the present disclosure, a user may wish to connect a new IoT device (e.g., node 310) to a home/SoHo network (e.g., LAN 320), in order to access various applications, sites, and/or services. Using these applications, sites, and/or services, the user may be able to, for example, visualize his/her weight loss or share videos via a smartphone where visualization of the video is possible, the smartphone being potentially on the home network (e.g., within LAN 320) or roaming on the Internet. Using the techniques herein, the user may browse a page in a bubble care management system (e.g., server/service 380) and may indicate that the IoT device is a new device. Notably, only minimal information about the device may need to be entered, such as device type, an image/picture of the device, or the manufacture's web site, to be recognized by the bubble care management system.

In response to the registration request regarding node 310, server/service 380 may instruct networking device(s) 340 to form a new virtual overlay/“bubble” that may redirect some or all of the traffic associated with node 310 to server/service 380 for further processing. In some embodiments, server/service 380 may spawn a new virtual machine (VM) or container-based application associated with node 310 to specifically handle the traffic associated with node 310. In the case of VM-based implementations, each such application may be executed within its own separately run operating system with its own set of binaries and libraries, with a hypervisor overseeing the execution of each VM. In containerized implementations, however, the operating system itself, the binaries, and/or libraries may be shared across applications as necessary, on server/service 380. According to the techniques described herein, the VM or containerized application of server/service 380 for node 310 may auto-configure an IP prefix, such as an IPv6 unique local address (ULA) or an IPv4 private address, that is forged on the fly for the virtual overlay of isolation network 370.

In some embodiments, such as for a wireless IoT node, server/service 380 may send the unique SSID (e.g., a virtual-SSID) for isolation network 370 to a user, as well as a password, if needed. Server/service 380 may also send this identifier to networking device(s) 340 of LAN 320, instructing these devices to accept a new Wi-Fi device having the established SSID/password. Note that the password may be optional since the SSID may not be exposed by the AP in its beacon, since it is not a real SSID. A similar approach may be taken in the wired case, such as by generating and sending a PAN-ID.

Thus, according to the techniques described herein, the user may enter the virtual SSID and password (if needed) into node 310 as if they were normal Wi-Fi credentials. The networking device(s) 340 (e.g., a wireless AP) may then send a beacon looking for the SSID that was programmed, per normal Wi-Fi behavior. Since this SSID has been communicated to the device AP and/or network gateway, node 310 would therefore be allowed in and associated. The authentication phase based on the SSID/password can be handled either at the device AP or the bubble care VM. For example, in a controller model, the controller may perform the L2TP to the bubble care VM. Traffic from node 310 may, in some embodiments, be encrypted with a particular session key and would not be visible from other devices/nodes which use different keys and network settings.

According to further aspects of the techniques herein, the device (e.g., the bubble care management service) may also instruct networking device(s) 340 to bridge/tunnel (e.g., using L2TP) all the datagrams associated with the SSID to the particular new bubble care VM or container running on server/service 380. In this way, communications between node 310 and server/service 380 may only occur using tunnel 390 within isolation network 370.

Networking devices 340 may bridge some or all of the traffic associated with node 310 to server/service 380, based on an established policy. In some embodiments, server/service 380 may also train a learning machine-based behavioral model for node 310 based on the received traffic associated with node 310. For example, the VM or containerized application that assesses the traffic associated with node 310 may emulate the expected networking device(s) 340 and any other servers or devices (e.g., a DNS server, etc.), from the perspective of node 310. To do so, fields, such as the prefix in a router advertisement, may be filled with the forged ULA/private addresses generated for this virtual overlay. In doing so, the machine learning-based model can “learn” the traffic behaviors associated with node 310.

Since the interaction with the network appears “normal” from the perspective of node 310, node 310 forms or obtains IP addresses and is able to communicate with the Internet via the virtual overlay of isolation network 370, but only if the destination is authorized by server/service 380. For example, note, as shown in FIG. 3B, site/service 5 (365) and site/service 6 (366) are not part of the virtual overlay of isolation network 370 and, as such, would not be accessible to node 310 (e.g., server/service 380 may drop traffic from node 310 to these destinations).

Authorized sites/services may be those that have been determined, based, for example, on the type of node 310, to be necessary (e.g., based on the information regarding node 310 in the registration request), preferable, and/or safe for the device to access. For example, remote sites/services that provide configuration management, software management (such as a vendor support site), security posture management, and/or various data publishers and subscriptions (e.g., YouTube, Google, etc.) may be authorized for inclusion in isolation network 370. Authorization may be based on either a pre-established knowledge base, which may be related to the particular brand/model/type of IoT device, or may be determined from information available related to the device. For example, a particular IoT device model may be permitted to connect to the manufacturer's site for downloading system software or to an application store for resident applications for that particular device. Authorized sites may also be determined based on target site reputation and/or heuristically.

The accessible destinations for node 310 may also be based in part on the behavioral model for node 310. For example, in cases in which the exact type of node 310 is unknown, the behavioral model of server/service 380 may be used to determine the type of node 310 and its authorized destinations. In another embodiment, the model may be used to detect and block anomalous traffic associated with node 310 (e.g., sudden and unexpected increases in traffic, etc.).

As shown in FIG. 3B, communications from node 310 are received at server/service 380 through bridge/tunnel 390 from networking device(s) 340, which helps to implement the virtual overlay of isolation network 370. In this way, node 310 and its communications are protected within isolation network 370 and are only permitted to specified authorized destinations, thereby preventing access to node 310 and protecting LAN 320 from external potential threats. Server/service 380 may either proxy the request or may extend the ULA overlay to include a particular application. As a specific example, if a smartphone is used as a display, an application available on the smartphone may terminate a L3 overlay (e.g., MIPv6 homed at the bubble care VM) that enables mobility. The VM of server/service 380 may monitor the traffic and may bridge what is deemed to be legitimate to the smartphone over the MIPv6 tunnel.

Implementation of such overlay/isolation networks (e.g., a “bubble”) as described herein may be dynamic and may bootstrap, isolate, monitor, and manage computer devices, particularly IoT devices, through their lifecycles, thereby addressing one of the key inhibitors of massive IoT deployment. Additionally, isolation networks as described herein may be combined with behavioral analysis, applying the latest approaches to network isolation and mobility under the control of learning machines (e.g., code implementing machine learning algorithms such as behavioral analytics) that may be located in the cloud to benefit from cross learning (e.g., learning from datasets belonging to different networks), though some actions can be delegated locally (e.g., Home Fog).

As described herein in some embodiments, a virtual overlay network (e.g., an isolation network/bubble) may be formed that includes the few logical network devices with which an IoT device primarily needs to communicate and, further, excludes unwanted or unneeded sites/services, such as a BotNet controller (e.g., Command & Control (C2) server) that could either trigger the device if already compromised or could become a potential target that the device would attack if already programmed for attack (e.g., if the device is in the bubble). The virtual overlay described herein may protect the IoT device from remote attackers that would attempt to login to the device and compromise it, whether the attacker is far on the Internet (such as external network 330) or on the same home network (such as LAN 320). The virtual overlay network may also enable transparent connectivity to mobile personal devices such as an application/display in a smartphone.

As an intelligent protection, the isolation network (e.g., the virtual overlay network) may leverage rule-based and machine learning (ML) approaches. These techniques may be used to profile the device to determine its type, so as to derive appropriate management techniques (e.g., http html page on poor 80 in the device) and the needs for connectivity. Furthermore, the flows from/to the devices may thereby be validated and misbehaviors detected. In addition, appropriate connections to Internet services may be allowed (e.g., software upgrade, publish/subscribe servers, management, etc.) inside the virtual overlay and, in some embodiments, multiple local devices may be allowed inside the same “bubble” with the capability to either monitor or intercept the traffic at some intelligence point in the cloud or to let the traffic flow locally with no data flowing outside of the device network (e.g., a LAN or WLAN). Rule-based and ML approaches may also be used to generate and push a configuration for the device that is adapted to the device type, including dedicated home SSIDs and passwords, root passwords, management servers and passwords, URL of support servers such as software update, etc., all based on simple user input, device profiling, and potential policy rules learned for the device profile. Furthermore, a set of rules may be generated and pushed to the first hop the device connects to (e.g., a device AP, a gateway, etc.) to allow and control shortcutting of specific flows between specific devices. Web pages that have never been seen can be understood, recognizing fields and generating filled forms automatically.

In some embodiments, the techniques described herein are based on the particular mechanisms that may allow formation of a virtual overlay to isolate a device in a local network (e.g., an IoT device), to extend the virtual overlay to the cloud by creating a bubble care/isolation application instance in the cloud, and to bridge the device traffic to the isolation application instance. The techniques may leverage learning machines (e.g., combination of rules and machine learning algorithms) to emulate the interactions with routers from the bubble care/isolation application instance so the device starts normal L2/L3 activity. Said differently, the techniques described herein may use newly defined learning machine based mechanisms to isolate devices from the surrounding networks (e.g., LAN and the Internet), install the device in a virtual network (e.g., an isolation network) that is overlaid over the Internet, where the virtual network incorporates a “bubble care cloud” application that controls the connectivity of the device. Thus, in some embodiments, the techniques herein may provide full isolation of each device and the bridging to a virtual machine in the cloud on the fly, wherein the virtual machine may use artificial intelligence technology to respond to the device faking the required set of network devices.

FIG. 3C illustrates an example embodiment showing one potential implementation of server/service 380 in greater detail, according to various embodiments. As noted above, server/service 380 may comprise a single server or, alternatively as shown, several servers that operate in conjunction with one another to implement the techniques herein as part of a single remote service for the nodes in LAN 320.

In some embodiments, server/service 380 may comprise a provisioning server 391 and a traffic analyzer server 392. During operation, provisioning server 391 may instruct networking device(s) 340 to form a specific bubble/virtual overlay for one or more nodes in LAN 340 (e.g., isolation network 370). For example, provisioning server 391 may be an Identity Services Engine (ISE) from Cisco Systems, Inc., or similar server that performs the provisioning (e.g., based on the profile of node 310). In doing so, provisioning server 391 may instruct networking device(s) 340 to form a Layer 3 Virtual Extensible LAN (VXLAN) that directs traffic associated with node 310 to a traffic analysis server 392 for analysis.

During establishment of isolation network 370, provisioning server 391 may also instruct traffic analyzer server 392 to perform any number of functions on the traffic associated with node 310. For example, depending on the profile of node 310, provisioning server 391 may instruct traffic analyzer server 392 to perform firewall functions on the traffic, perform machine learning-based modeling of the traffic, or the like. In some embodiments, provisioning server 391 may instruct traffic analyzer server 392 to execute these functions within a VM or container associated with the specific isolation network 370.

In some cases, Application Policy Infrastructure Controller (APIC) 393 in server/service 390 may also provide application user group information to provisioning server 391 and/or to traffic analyzer server 392. Such information may be used by server 391-392 to help control the provisioning of isolation network 370 and/or the specific functions performed on the traffic by traffic analyzer server 392.

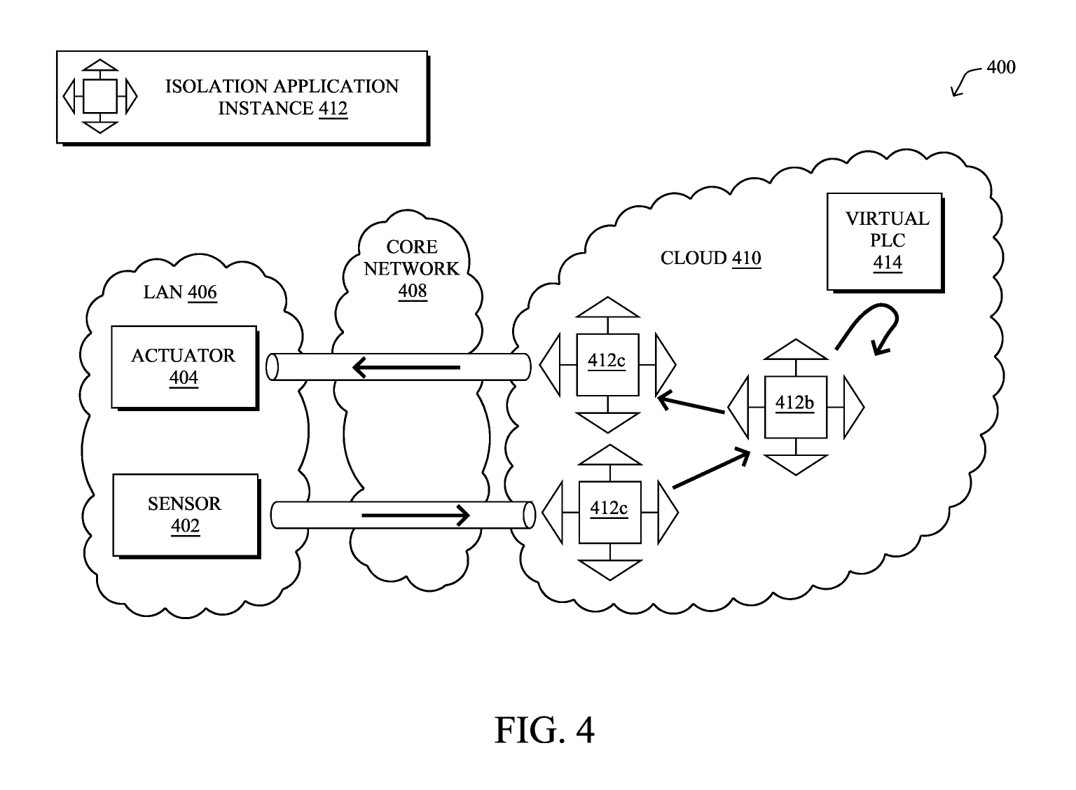

As noted above, the concept of isolation networking is an extreme instance of overlays whereby all the traffic to/from an IoT device, at least initially, is redirected to a cloud application for examination and reachability control. For example, FIG. 4 illustrates a potential control loop implemented using the techniques herein. As shown, network 400 may include a LAN 406 in which a sensor 402 and an actuator 404 are located. LAN 406 may itself be in communication with the cloud 410 via a core network 408 that may comprise a switched fabric, IP network, or the like.

At the heart of the control loop may be a programmable logic controller (PLC) that can be implemented as a virtual PLC 414 in cloud 410. During operation, sensor 402 may provide a sensor reading to virtual PLC 414. Based on the sensor reading, virtual PLC 414 may send control instructions to actuator 404. In turn, sensor 402 may capture and send a measurement regarding the environment affected by actuator 404 to virtual PLC 414, thereby allowing virtual PLC 414 to provide additional control, and closing the control loop.

According to various embodiments, each of sensor 402, actuator 404, and virtual PLC 414 may be assigned to a separate “bubble care”/isolation application instance 412. Notably, traffic from sensor 402 may be tunneled to isolation application instance 412a, traffic from cloud 410 may be tunneled back to actuator 404 via isolation application instance 412c, and virtual PLC 414 may also be assigned to its own isolation application instance 412b. In doing so, these components of the control loop may be isolated from one another, with any traffic having to pass between the corresponding isolation networks/bubbles. For example, for sensor 402 to send its sensor readings to virtual PLC 414, the reading must be passed from isolation application instance 412a to isolation application instance 412b. In turn, virtual PLC 414 may generate a control command for actuator 404 that must pass from isolation application instance 412b to isolation application instance 412c.

Traditional routing and forwarding in the network is either based on addresses (e.g. MAC or IP addresses) or on content, such as Content-Based Routing, Named Data Networking (NDN), Information Centric Networking (ICN), and the like. However, the implementation of isolation networks/bubbles via a virtualized cloud environment allows for new opportunities from a routing perspective. In various embodiments, a new form of routing may take place in the virtual world between the bubbles (e.g., between instances 412 in cloud 410), based on semantics that can be found in the packets. In some embodiments, this routing can also be based on application level information, such as contextual information related to the IoT object, and/or based on the general context of its operation. For example, as shown, information about sensor 402 and/or contextual information about its sensor readings can reside in cloud 410 and can be associated to the isolation application instance 412c that represents actuator 404, for purposes of routing between bubbles.

It can be remarked that other, and potentially multiple, services may be chained in such an architecture. For instance, one such service may be an application level gateway (ALG) for protocol translation between an industrial protocol spoken by sensor 402 and one spoken by actuator 404. As for cloud-based PLC 414, it may also make sense to allocate a bubble instance to the chained applications and then provide a common routing bus between bubbles, extending the example above to multiple types of flows and chained services. It also makes sense that the result of a micro service that was used by chained application A is available to chained application B.

Unfortunately, the initial packet of the traffic and the bubble context may not be all that is needed for optimal chaining. In addition, the results of the operations done to the packet by the micro-services can be useful to more than one application. Also, in the context of the IoT, there is a particular interest in forming all sorts of dynamic groups of destinations, e.g., all light bulbs of type X in room Y, and deliver trusted content to the devices that match the request. These groups may not be known in advance, since the query that isolates them can change per information being distributed. This creates a combinatory explosion of multicast destinations, and traditional address based multicast becomes impractical. In particular:
A device may belong to too many groups and cannot store as many addresses.
The needs are very dynamic, not all groups can be provisioned in advance.
Routing such as RPL multicast, would involve storing too many multicast routes.
DDoS attacks could be very destructive, considering the limited capabilities of the RPL networks and the IoT devices.

The only way traditional routing can address the above issues is broadcasting, and that becomes increasingly unfeasible as the IoT network grows in size. In the context of isolation networks, this would also result in n-number of unicast messages being propagated from the application back to the n-number of devices that are to receive the message. In addition, the very dynamic aspect of multicast groups in the IoT should be addressed in a manner that aligns with the needs of the application, as opposed to the traditional routing inside the local network.

Routing Traffic Across Isolation Networks

The techniques herein extend an isolation network system to protect cloud services and applications. In some aspects, the techniques herein provide for the tagging of packets with application layer information, which is made available to the next service(s), based on authorization. In further aspects, the results of micro-services applied to the packet may also be cached with the packet, to save processing along the way. In yet other aspects, the techniques herein allow traffic to be forwarded between different isolation application instances associated with different nodes in the deployed network.

Specifically, according to one or more embodiments of the disclosure as described in detail below, a cloud-based service instructs one or more networking devices in a local area network (LAN) to form a virtual network overlay in the LAN that redirects traffic associated with a particular node in the LAN to a first isolation application instance hosted by the service. The first isolation application instance receives the redirected traffic associated with the particular node. The first isolation application instance determines a routing path for the traffic that comprises one or more other isolation application instances hosted by the cloud-based service. The first isolation application instance tags the traffic to indicate the determined routing path. The first isolation application forwards the tagged traffic to a second isolation application instance along the determined routing path.

Illustratively, the techniques described herein may be performed by hardware, software, and/or firmware, such as in accordance with the isolation network process 248, which may include computer executable instructions executed by the processor 220 (or independent processor of interfaces 210) to perform functions relating to the techniques described herein, e.g., in conjunction with routing process 244.

Operationally, the creation of isolation networks allows for new forms of routing that can take into account not only the contents of a packet, but also additional information such as application-level information and/or contextual information about the sending node.

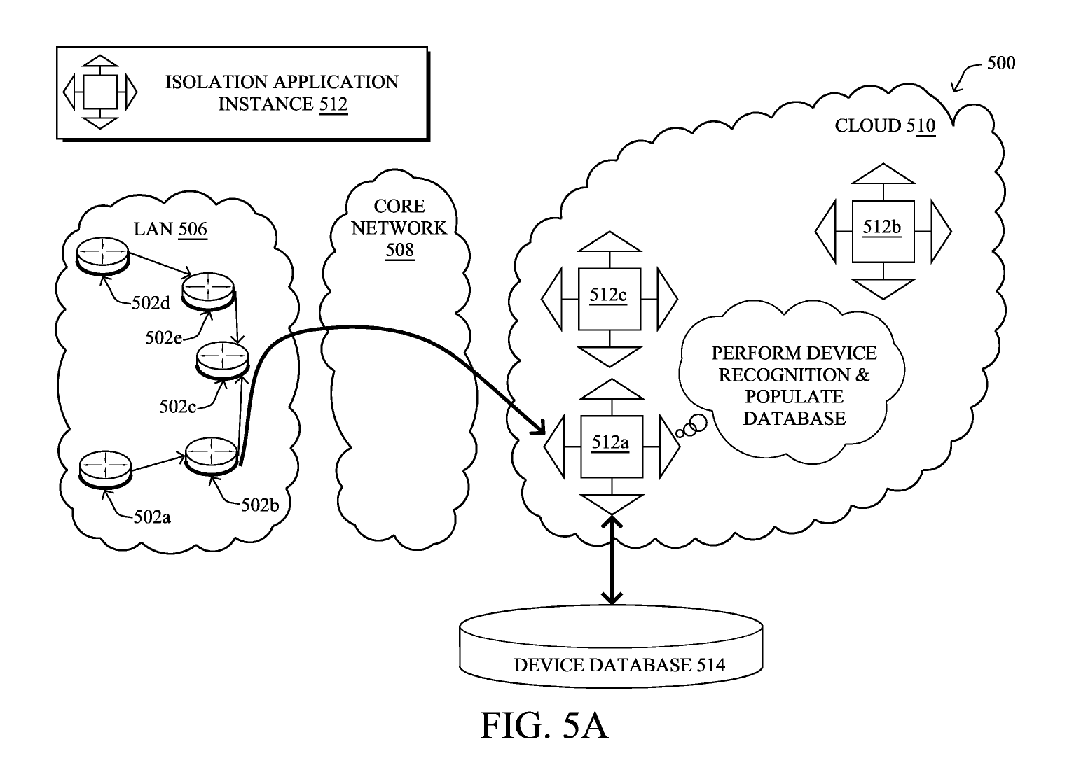

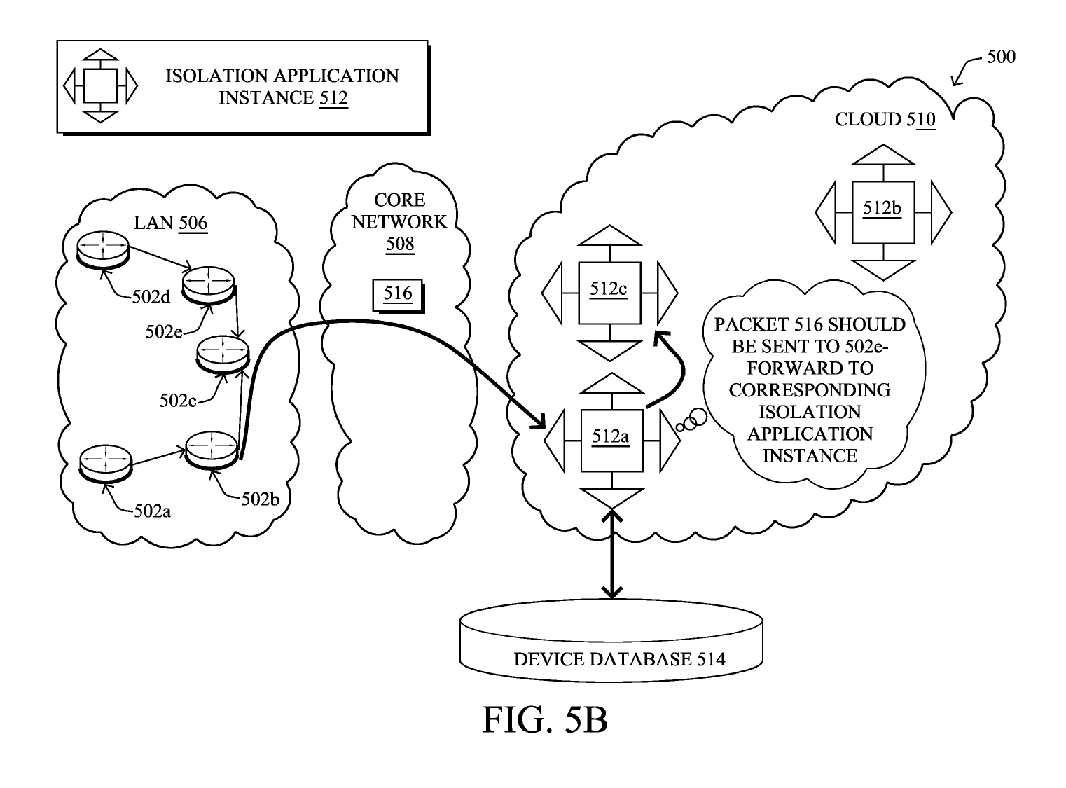

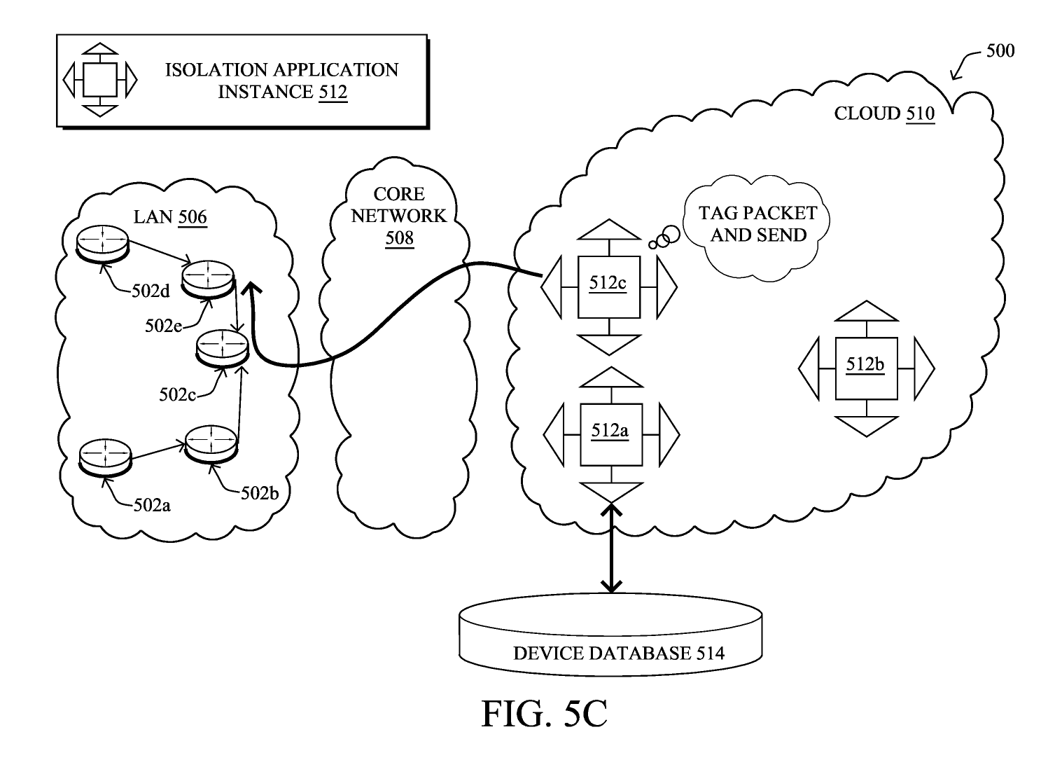

FIG. 5A-5C illustrates an example 500 of using a device database to control routing paths between isolation application instances, according to various embodiments. As shown, assume that LAN 506 includes any number of nodes 502 and communicates with a cloud 510 via a core network 508. In some implementations, nodes 502 may be IoT nodes, such as sensors or actuators. Using the techniques described above, traffic associated with a particular node, such as node 502b, may be rerouted to a corresponding isolation application instance 512 in cloud 510, such as instance 512a shown.

According to various embodiments, a device database 514 is introduced herein that is used to store information about nodes 502 and their respective traffic. During operation, database 514 may perform as a shared routing database among the various isolation application instances 512 in cloud 510. For example, in the case of traffic being redirected from node 502b to isolation application instance 512a, instance 512a (e.g., a “bubble instance”) may perform device recognition on the traffic and populate device database 514 with information about node 502b and its associated traffic.

Device database 514 may store various information about a given node 502 in LAN 506 that includes, but is not limited to, any or all of the following:
Device Type Information—This may indicate the specific device identifier (e.g., MAC address, manufacturer-defined ID, etc.) of the node, the make or model of the node, and/or a general categorization of the node (e.g., identifying the node as smart lighting, a thermostat, etc.).
Traffic Profile Information—This may indicate the characteristics of the traffic associated with the node such as when the traffic is expected to be sent or received by the node (e.g., a sensor reports its reading every minute, hour, day, etc.), the byte sizes of the traffic packets, the source and/or destination of the traffic (e.g., addresses, ports, etc.), the protocols used, and the like.
Network Information—This may indicate the physical and/or network location of the node, the time of installation of the node, the lifetime of the node, neighbor information for the node, etc.

During use, an isolation application instance 512 that receives redirected traffic from a node 502 may access device database 514 to automate the connection between the node and its traffic destination(s). For instance, device database 514 may describe the role of a node/device in a hub and spoke client-server protocol operation, which protocol is handled, which type of peers are expected, etc. This allows device database 514 to be used for any or all of the following: 1.) associating/peering nodes together per application request, 2.) forwarding packets between isolation application instances 512 for the corresponding nodes, and/or 3.) forwarding packets between bubbles of non-associated devices on demand (or a remote application).

With respect to associating nodes together, device database 514 may match nodes together that the application expects to see permanently connected. This creates a trusted relationship between bubbles/isolation application instances and enables a rapid forwarding of packets in cloud 510.

One potential use case for the association of nodes in device database 514 is the case in which a user deploys a sensor and an actuator in a certain room. Using the techniques herein, as opposed to relating the IoT nodes and the application (e.g., by typing a network protocol address in the application), node setup simply requires relating the isolation application instances/bubbles for the nodes together. This is much simpler, since the bubble can be found in the device database by location of the served node, device type of the node, time of device bootstrap, node state information (e.g., not connected yet, etc.), or the like. Accordingly, the user may operate a user interface to the service in cloud 510 whereby the application queries the sensor and actuator from the database, and then associates them to form control loops, without ever having to contact the nodes themselves.

In another use case example, assume that a new lighting system is installed with lamps that can change color and control switches that actuate the lamps. Local physical switches must be paired to the lights in the same room, global logical switches (in lighting applications) must be able to contact lamps at the level of rooms, levels, buildings, groups of buildings. When a lamp or a switch is connected to the network, it is recognized by the bubbles/isolation application instances that serve it and that populate the database (e.g., the type of lamp is ‘X’, the lamp communicates over RPL/IP in the network, the lamp boots at a certain time, the lamp can communicate using lightML, etc.). In such a case, a corresponding switch can be associated to one or more lights in the cloud, and then optimized forwarding of packets can be put in place in the network to bypass the cloud.

Using the techniques herein, the destination IP address from the sensor node can be set to a well-known anycast address that means e.g., let the cloud-based service pass that content to the appropriate consumers. To select a destination, such as an application or other target node, the isolation application instance handling the traffic for the node may take into account the type of the sending device, its state, etc., to identify the proper destination(s) for the traffic and route the traffic, accordingly, between the isolation application instances in the cloud service.

For purposes of illustration, assume that in FIG. 5B packet 516 sent by node 502b is redirected to isolation application instance 512a in cloud 510. In turn, isolation application instance 512a may assess packet 516 and perform a lookup in device database 514, to determine that packet 516 should be sent to node 502e. Accordingly, isolation application instance 512a may forward packet 516 on to isolation application instance 512c, which is associated with node 502e and isolates node 502e from interacting directly with the other nodes 502. Then, as shown in FIG. 5C, isolation application instance 512 may tag packet 516 appropriately, for delivery to node 502e in LAN 506.

The above forwarding approach serves the lighting switch use case from earlier, as well as direct control applications that do not involve a virtual PLC. Say, for example, that a node in a RPL non-storing domain produces data, but does not really know or care which destination(s) actually need that packet. After all, this is more the concern of the application. IP unicast transmission is not fully adapted, since the node should know the IP address of the destination, and there should be routing in place to get there. However, using the isolation network techniques herein, all the traffic from the node may be sent to the cloud and destination selection can be delegated to the node's isolation application instance that has more information about the node (e.g., due to the device database) and is more dynamic than configuring the node directly.

In a particular embodiment, the role of the RPL root, which is a very special role in an IoT network and typically requires a lot of memory for large networks, may be virtualized in the cloud. In doing so, source route tagging can be computed in the cloud, as well. To forward a packet back to the target/destination node, a bubble/isolation application instance then tags the packet appropriately to be routed back down to the node that it serves. If the bubble participates to RPL non storing mode, this may involve routing down the RPL DODAG. This way, all the routing down the DODAG is actually computed in the cloud, without the need of a dedicated device. For example, in the case where isolation application instance 512c is to send traffic back to node 502e, instance 512c may tag the packet appropriately and route the packet back down to the RPL DODAG of LAN 506 for delivery to node 502e.

At some point in time, it may also be the case that a shortcut path may be installed in LAN 506, to bypass sending certain traffic up to cloud 510 (e.g., large and safe video streams, etc.). If LAN 506 is an RPL-based network, the cloud-based service in cloud 510 may determine that traffic between certain nodes 502 satisfy predefined rules (e.g., access control lists, etc.). In turn, the corresponding isolation application instances 512 may control the networking devices of LAN 506, to allow these nodes 502 to communicate directly via LAN 506, instead of rerouting the traffic to cloud 510. In further embodiments, if the network is a software defined network (SDN), such as a RPL DAO projection, then the routes in the virtual world between bubbles/instances may be pushed to the real world, along with filter rules, to enable shorter paths and limited latency in the local IoT network.

In various embodiments, the cloud-based service can also forward packets between bubbles/isolation application instances of non-associated nodes, on demand. For example, assume that node 502b is a light switch and node 502e is a lamp. Control over the lamp may entail passing traffic from isolation application instance 512a associated with node 502b to isolation application instance 512c associated with node 502e, based on the device associations in device database 514. However, now assume that control over the shades in the room is also to be provided when the light switch is actuated. In such a case, the application packet from node 502b may be packaged with a query that indicates the target device(s) in a fashion that is meaningful to the application, and can be looked up in device database 514. For example, the application traffic from node 502b may also specify “I want to actuate any automated shades in the location of the lamp.” In turn, isolation application instance 512a may use database 514 to identify any shades in the same location as the lamp and forward the packet to their corresponding isolation application instances 512. Notably, if the result of the local check above is that the packet is to be sent from a node or application to non-associated devices, then the instance 512 may also query a forwarding rule in database 512 for that packet.

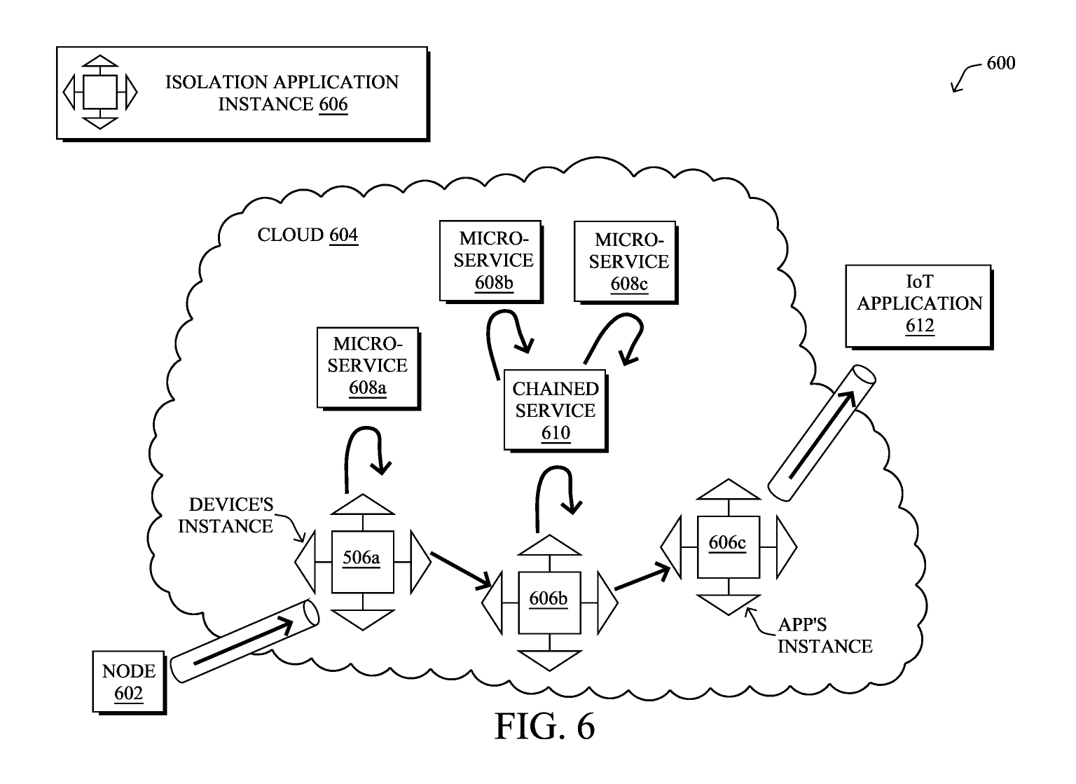

In addition to simply passing traffic between isolation application instances associated with nodes in a LAN, rerouting traffic from the LAN to an isolation application instance also allows for the application of cloud-based micro-services to the traffic. FIG. 6 illustrates an example 600 of using bubble/isolation application instances to chain micro-services. As shown, assume that traffic from node 602 is tunneled to its associated bubble instance 606a in cloud 604. In particular, isolation application instance 606a may apply a micro-service 608a to the traffic, before routing the traffic on to instance 606b. In some embodiments, instance 606b may be associated with a chained service 610 that applies multiple micro-services 608 to the traffic. For example, chained service 610 may first apply micro-service 608b to the traffic and then micro-service 608c. In turn, instance 606b may route the traffic to instance 506c, which is associated with an IoT application 612 that may be hosted in cloud 604 or may be located remotely.

Micro-services 608 may be any number of different types of virtualized IoT services such as, but not limited to, RPL source routing computations, Service Function Chain (SFC) computation, protocol translation between industrial protocols, virtualized PLCs, and the like. Using the techniques herein, a bubble/isolation application instance may be associated with each of these micro-services, as well as to the final application, if any. However, as noted above, the initial packet and bubble context may not be enough for optimal chaining of micro-services across different isolation application instances. In addition, it may be beneficial in some situations to share results between micro-services and/or different applications.

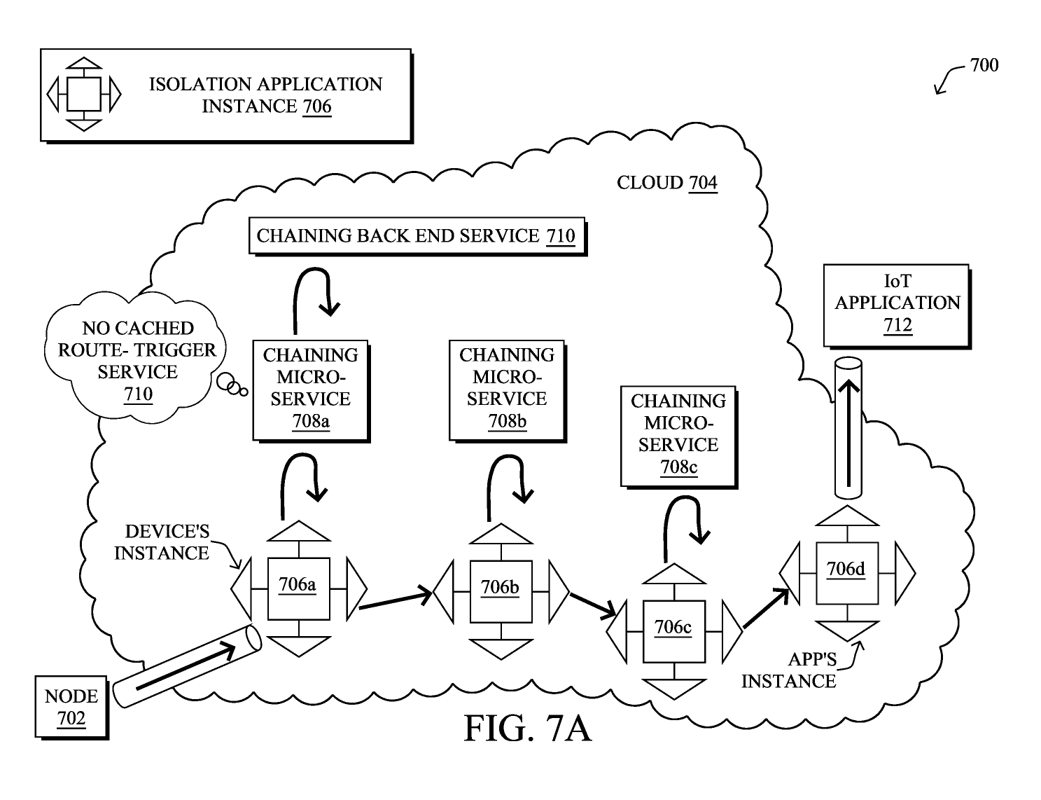

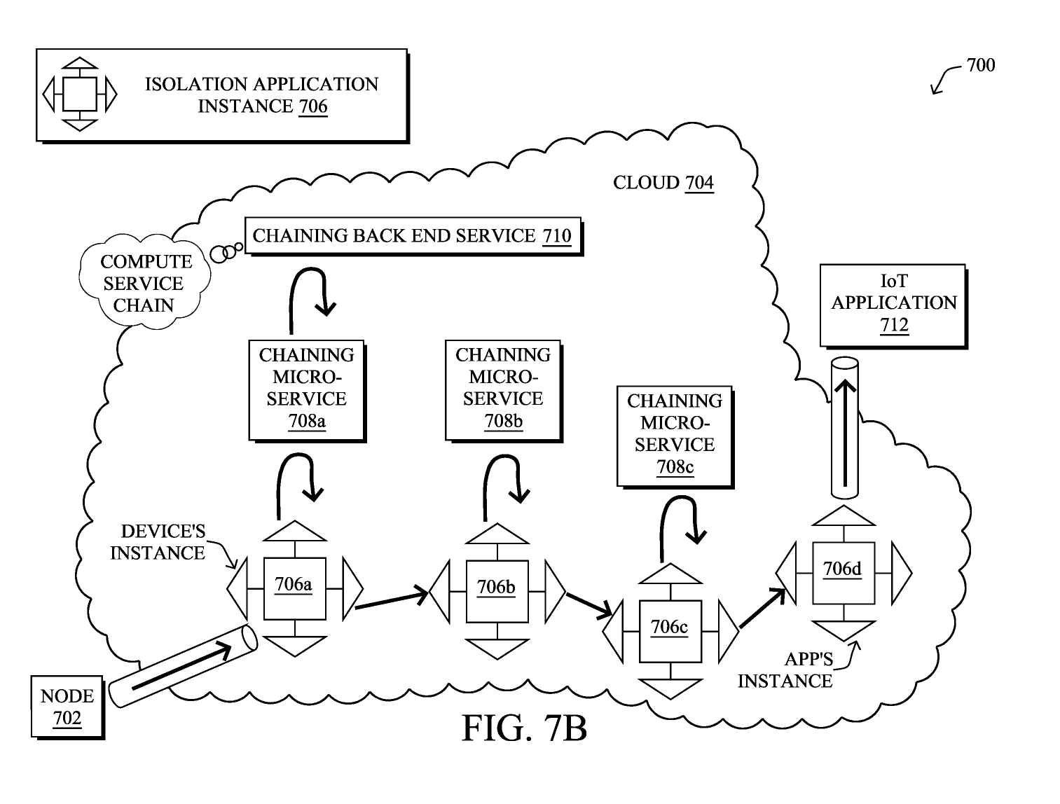

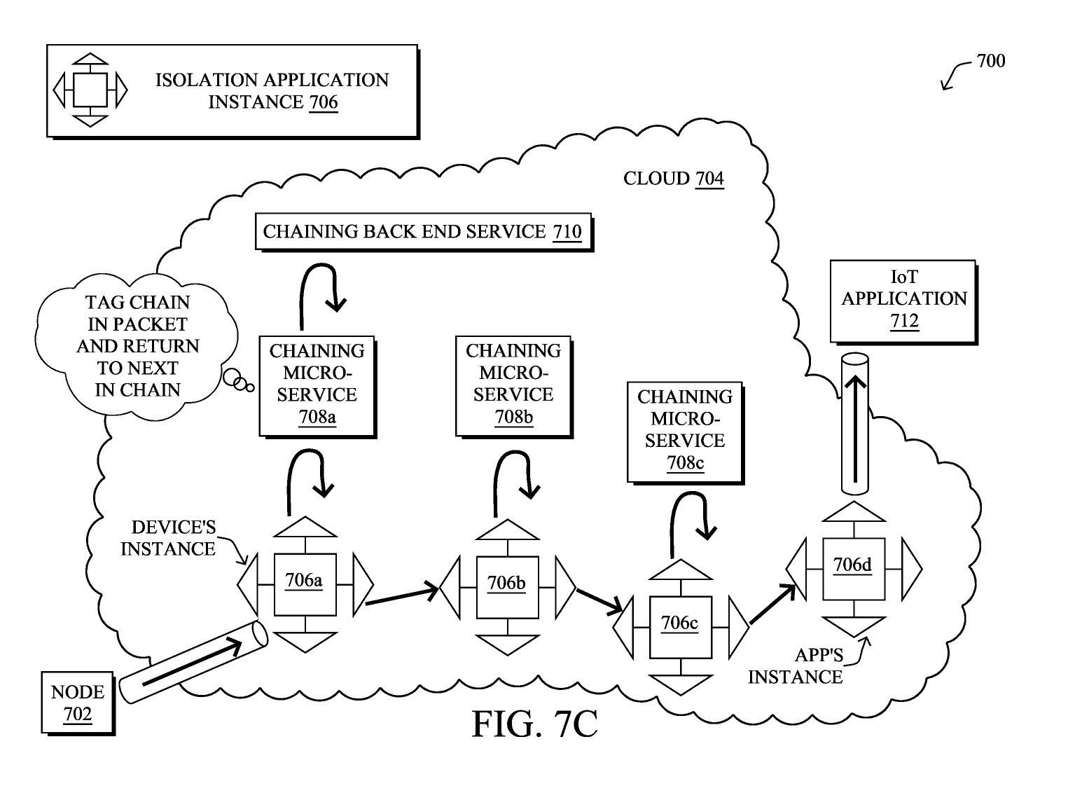

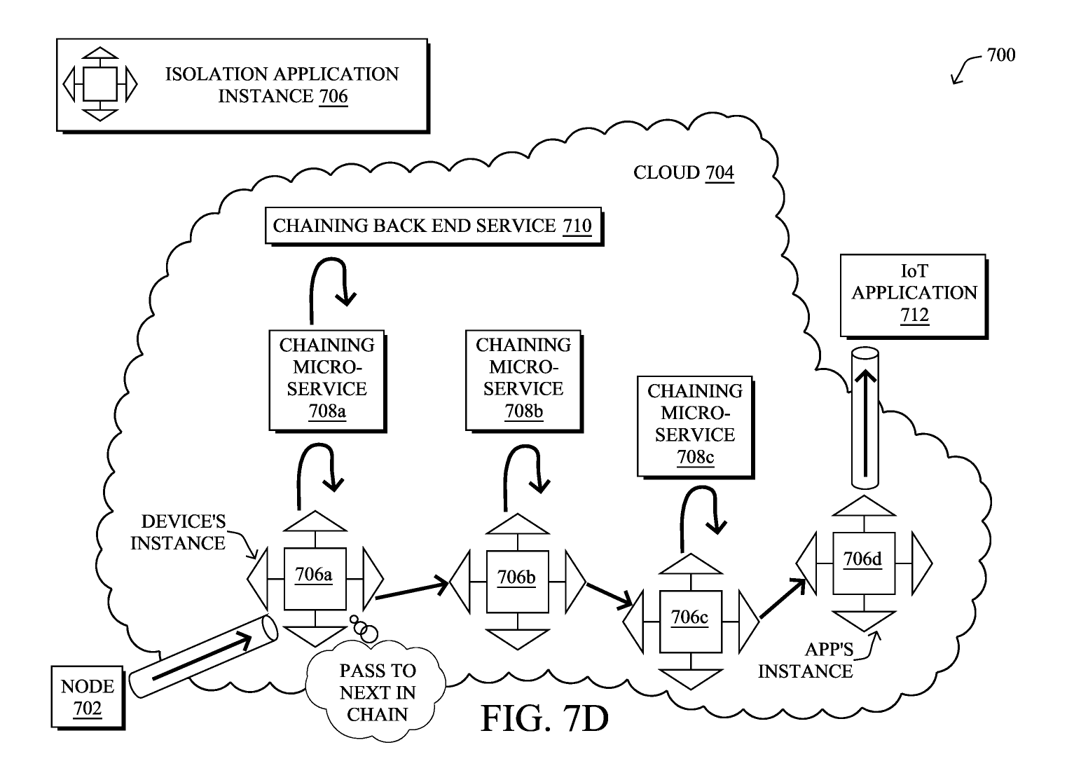

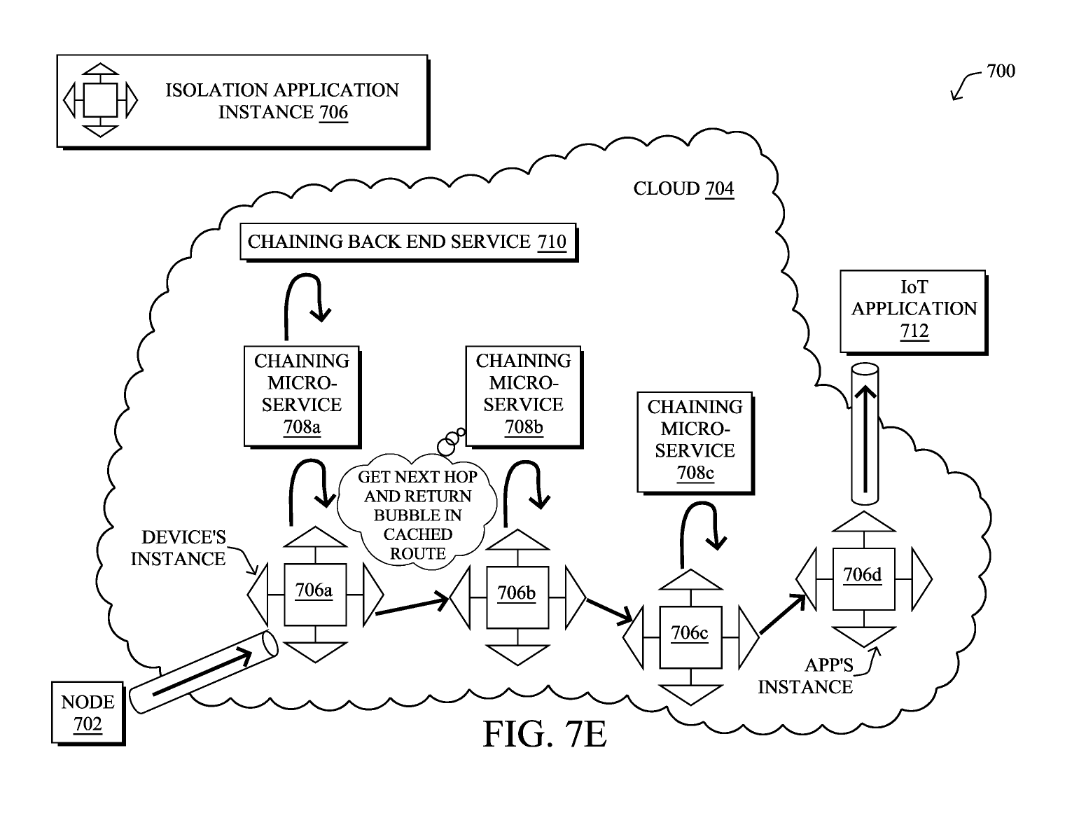

FIG. 7A-7E illustrates an example 700 of forwarding traffic between micro-services associated with different isolation application instances, according to various embodiments. As introduced herein, new forms of tags may be attached to the packets as they flow from bubble to bubble, in order to chain those services and run them optimally. These tags may be used for any or all of the following:
Enable source-routed service chaining between bubbles, adapting the content to present it to the service, with innocuousness checks in and out.
Cache the result of micro-service operations that were already run on the packet, to save common processing.
Store state that the next chained service(s) may be authorized to read or update, under control of the serving bubble.

For example, as shown in FIG. 7A, assume that traffic from node 702 is redirected to its associated isolation application instance 706a in cloud 704, with the ultimate destination being IoT application 712. However, before delivery to IoT application 712, a number of chaining micro-services 708 are to process the traffic. In various embodiments, the cloud service in cloud 704 may also comprise a chaining backend service 710. During operation, a micro-service 708 may act as the front end interface for chaining backend service 710, to compute the service chain for the packet.

In response to receiving traffic from node 702, isolation application instance 706a may send the traffic to micro-service 708a which first determines whether a route has already been cached for the traffic. If so, micro-service 708a may tag the traffic appropriately and perform its corresponding operation to the traffic, before forwarding the traffic along the cached route (e.g., to one or more other instances 706). For purposes of illustration, assume that no route has been cached for the traffic from node 702. In such ca case, micro-service 708a may trigger chaining backend service 710 to compute the appropriate path/service chain for the traffic.

As shown in FIG. 7B, chaining backend service 710 may compute the appropriate service chain for the traffic and, as shown in FIG. 7C, micro-service 708a may tag the traffic for routing along the computed service chain. In some cases, chaining backend service 710 may build the service chain so as to run all common micro-services first (e.g., a security check, parsing, etc.), then forming a tree that branches off after common micro-services are applied to the traffic. The tree may sort the target devices per protocol they support, and branch off for each protocol for translation. Then the tree may branch off again for distribution to the bubbles that handle the target devices. In other words, the service chain computed by chaining backend service 710 is a graph of instances 706 and not simply a serial list. In addition, it is agnostic to the functions hosted by the bubbles.

Based on the tagging by micro-service 708a that represents the service chain computed by chaining backend service 710, isolation application instance 706a may determine that the tagged traffic should then be passed to instance 706b after processing by micro-service 708a, as shown in FIG. 7D. In turn, as shown in FIG. 7E, instance 706b may get the next hop information from the tagging of the traffic, to determine that the traffic should then be routed to isolation application instance 706c, after application of its own micro-service 708b to the traffic. This process may be repeated any number of times along the route.

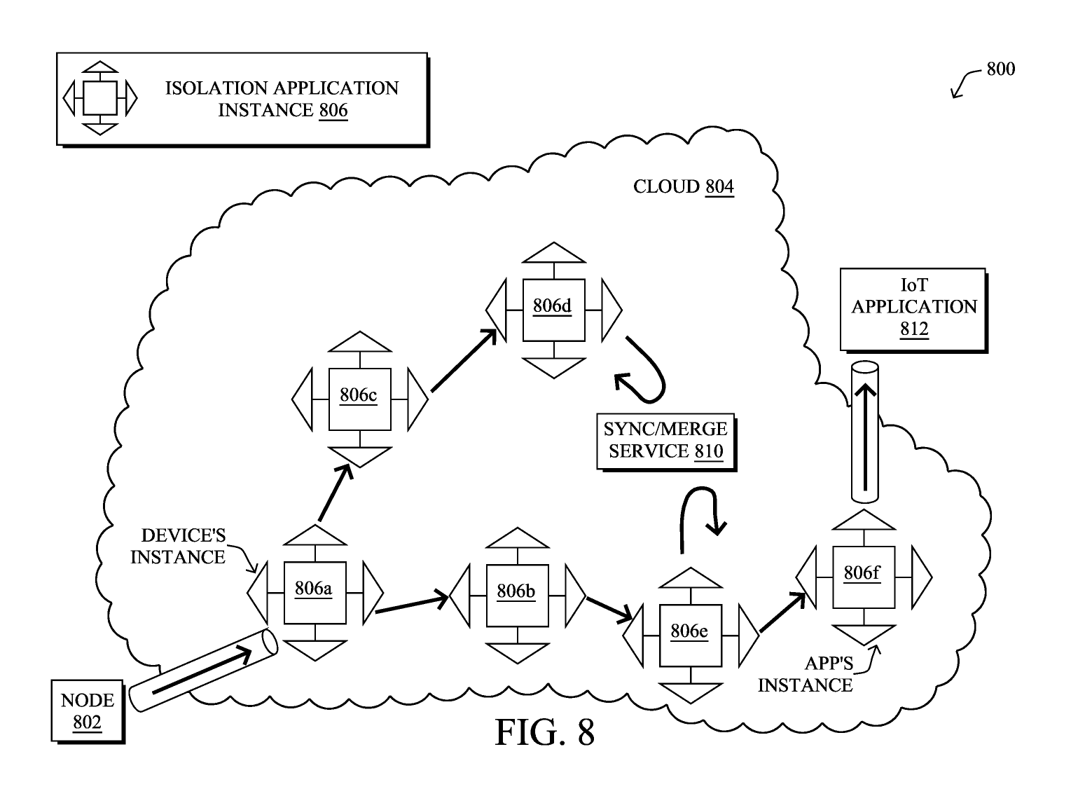

As noted, the chained structure and associated routing path between instances 706 may be more complex than a simple chain. For example, as shown in FIG. 8, assume that the traffic sent by node 802 is redirected to isolation application instance 806. In turn, instance 806a may leverage the chaining backend service described above, to tag and send the traffic through a DAG of other instances 806 for application of their own micro-services. At some point, branches of the traffic can also be synched/merged by a micro-service 810, before forwarding the traffic to IoT application 812.

It is also possible to orchestrate micro-services along the path such that they operate at particular times, in order to enforce some determinism in the process. In some embodiments, the micro-services can act as a rendezvous point, holding the traffic until all other micro-services have completed their processing. Other micro-services may hold their processing of the traffic, for instance, until a particular time is reached when the micro-service should execute. In other words, the chaining backend service may intelligently build a service chain across any number of instances/micro-services, prior to branching off, to parallelize some execution and then either distribute the result to multiple parties, or reconcile the threads to aggregate the results.

Another function of the chaining backend service of the cloud-based isolation service, such as chaining backend service 710 shown in FIGS. 7A-7E, may be to cache the results of micro-service operations. In particular, on the first occurrence of a call to a service chain computation micro-service (e.g., micro-service 708a), chaining backend service 710 has to run, but the cached results can be used for subsequent calls. In some embodiments, this cache may be stored with the packet as a tag by chaining micro-service 708a. In one embodiment, micro-service 708a can protect this information and does not need to make it readable by any other micro-service 708.

In some cases, a chained micro-service 708 may benefit from a results or state information from a previous micro-service in the chain that processed the traffic. For example, assume that micro-service 708b determines that the traffic passed all security checks, parsed information from the packet, or the like, that could be of use to a subsequent micro-service, such as micro-service 708c. In various embodiments, any given bubble/isolation application instance 706 or micro-service 708 may indicate to chaining backend service 710 what states need to be stored with the packet and which other micro-services 708, or groups of micro-services, have read or write access to that information. Notably, a given bubble/isolation application instance 706 may provide the APIs to store, read, and write information associated with the packet, to any authorized system. This information is then available to the next micro-services along the routing path and/or the final application.

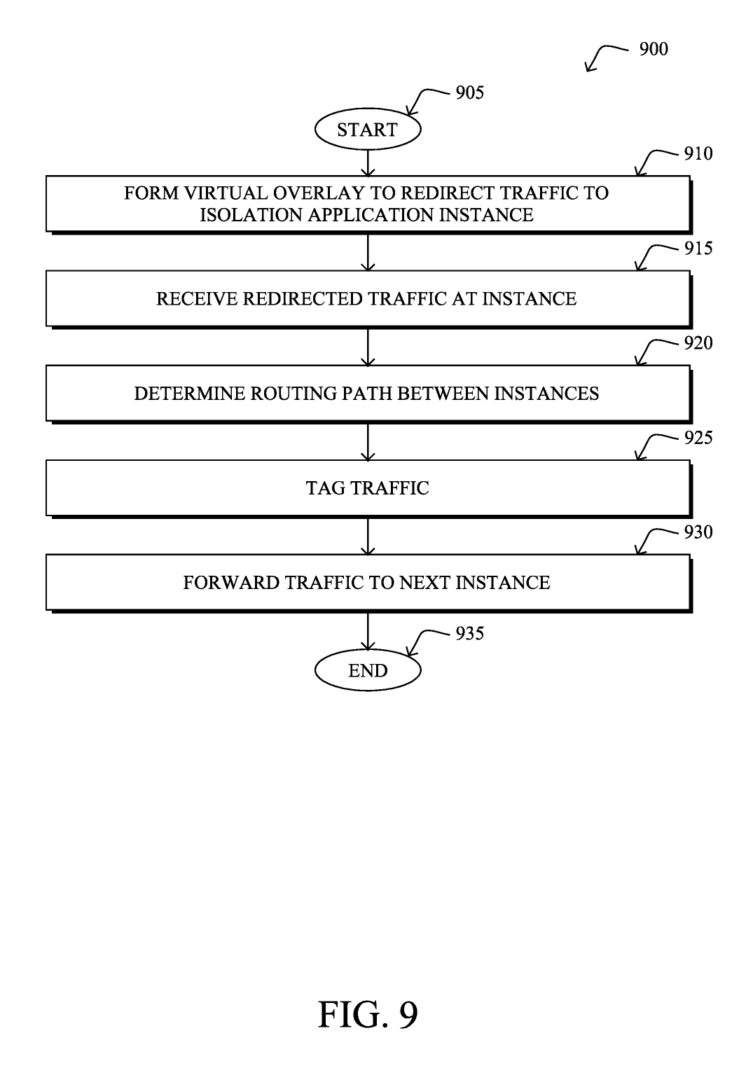

FIG. 9 illustrates an example simplified procedure for forwarding traffic between isolation application instances, in accordance with one or more embodiments described herein. For example, a non-generic, specifically configured device (e.g., device 200) may perform procedure 900 by executing stored instructions (e.g., process 248), to implement a cloud-based isolation network service. The procedure 900 may start at step 905, and continues to step 910, where, as described in greater detail above, the service may instruct one or more networking device in a local area network (LAN) to form a virtual network overlay in the LAN that redirects traffic associated with a particular node in the LAN to a first isolation application instance of the service. The virtual network overlay may act as an isolation network and may, in some embodiments, include the particular node in the LAN, the one or more networking devices of the LAN, and one or more destinations with which the particular node is authorized to communicate.

At step 915, as described in more detail above, the first isolation application instance of the service may receive the redirected traffic associated with the particular node. The traffic may be wired or wireless communication. In some embodiments, the node may be an IoT device communicating via one or more networking devices of the LAN, such as a wireless access point, switch, router, gateway, or combinations thereof.

At step 920, the first isolation application instance hosted by the service may determine a routing path for the traffic that comprises one or more other isolation application instances hosted by the cloud-based service, as described in greater detail above. In some embodiments, the instance may access a device database that stores contextual information about the particular node and use this information as part of the routing determination. For example, the instance may determine that the traffic should be sent to another isolation application instance associated with another node in the LAN, a virtual PLC, an IoT application (e.g., a SCADA application, etc.), or the like. In further embodiments, the instance may determine a routing path among different instances that apply various micro-services to the traffic. Such micro-services may include, but are not limited to, security checks, calculations, packet parsing, and the like.

At step 925, as detailed above, the first isolation application instance may tag the traffic to indicate the determined routing path. Such tagging may indicate the ordered set of isolation application instances through which the traffic should be sent. In various embodiments, the source route tagging may be logical (e.g., “run this service with these parameters then this one then this one”) or may be physical (e.g., “use VM #4 on server #3 in cluster #2 at time t”). Note also that the path, in some cases, may not be simply a linear path, but can also be in the form of a DAG, tree, or the like, whereby the traffic may be sent across different branches at the same time. This is particularly true in the case of the application of micro-services to the traffic by the different instances.

At step 930, the first isolation application instance may forward the tagged traffic to a second isolation application instance along the determined routing path, as described in greater detail above. The second instance may, for example, be associated with another node in the LAN and forward the traffic to the other node (e.g., by computing a source route for the traffic, etc.), a certain application, a virtual PLC, or a micro-service that acts on the traffic. Procedure 900 then ends at step 935.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, leverage the concept of isolation networks to perform various forms of routing that would not be possible in many traditional networks. In some aspects, contextual information about the isolated node may be used as part of the routing decision, allowing different connections to be established automatically and on the fly. In further aspects, the isolation network concept can also be used to implement the chaining of micro-services that are applied to the traffic.

While there have been shown and described illustrative embodiments that provide for routing traffic across isolation networks, it is to be understood that various other adaptations and modifications may be made within the spirit and scope of the embodiments herein. For example, while certain embodiments are described herein with respect to using certain protocols, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
instructing, by a cloud-based service, one or more networking devices in a local area network (LAN) to form a virtual network overlay in the LAN that redirects traffic associated with a particular node in the LAN to a first isolation application instance hosted by the service;
receiving, at the first isolation application instance hosted by the cloud-based service, the redirected traffic associated with the particular node;
determining, by the first isolation application instance hosted by the cloud-based service, a routing path for the traffic that comprises one or more other isolation application instances hosted by the cloud-based service;
tagging, by the first isolation application instance hosted by the cloud-based service, the traffic to indicate the determined routing path; and
forwarding, by the first isolation application instance hosted by the cloud-based service, the tagged traffic to a second isolation application instance along the determined routing path.

2. The method as in claim 1, wherein determining the routing path for the traffic comprises:
retrieving, by the first isolation application instance, characteristics of the particular node from a database of device characteristics, wherein the determined routing path is based in pat on the characteristics of the particular node.

3. The method as in claim 1, wherein the particular node comprises a sensor, the traffic comprises a sensor reading, and at least one of the other isolation application instances is associated with a virtual programmable logic controller.

4. The method as in claim 1, wherein two or more of the other isolation application instances are associated with chained micro-services that perform operations on the tagged traffic.

5. The method as in claim 4, further comprising:
sharing, by the service, results of the operations between the two or more other isolation application instances.

6. The method as in claim 4, wherein determining the routing path for the traffic comprises:
computing, by the service, a directed acyclic graph of isolation application instances for chained micro-services that perform operations on the tagged traffic.

7. The method as in claim 1, wherein the traffic is tagged with Routing Protocol for Low-Power and Lossy Network (RPL) source routing information, the method further comprising:
forwarding, by one of the isolation application instances in the routing path, the traffic to a second node in the LAN using the RPL source routing information, wherein the forwarding isolation application instance is associated with the second node.

8. The method as in claim 7, further comprising:
instructing, by the service, the one or more networking devices in the LAN to forward the traffic associated with the particular node to the second node via the LAN, instead of redirecting the traffic to the first isolation application instance hosted by the service.

9. The method as in claim 1, further comprising:
extracting, by the service, a query from the traffic associated with the particular node;
identifying, by the service, a second node in the LAN based on the query, wherein at least one isolation application instance in the determined routing path is associated with the identified second node.

10. An apparatus, comprising:
one or more network interfaces to communicate with a network;
a processor coupled to the network interfaces and configured to execute one or more processes; and
a memory configured to store a process executable by the processor, the process when executed configured to:
instructing, by the apparatus, one or more networking devices in a local area network (LAN) to form a virtual network overlay in the LAN that redirects traffic associated with a particular node in the LAN to a first isolation application instance hosted by the apparatus;
receiving, at the first isolation application instance hosted by the apparatus, the redirected traffic associated with the particular node;
determining, by the first isolation application instance hosted by the apparatus, a routing path for the traffic that comprises one or more other isolation application instances hosted by the apparatus;
tagging, by the first isolation application instance hosted by the apparatus, the traffic to indicate the determined routing path; and
forwarding, by the first isolation application instance hosted by the apparatus, the tagged traffic to a second isolation application instance along the determined routing path.

11. The apparatus as in claim 10, wherein the apparatus determines the routing path for the traffic by:
retrieving, by the first isolation application instance, characteristics of the particular node from a database of device characteristics, wherein the determined routing path is based in pat on the characteristics of the particular node.

12. The apparatus as in claim 10, wherein the particular node comprises a sensor, the traffic comprises a sensor reading, and at least one of the other isolation application instances is associated with a virtual programmable logic controller.

13. The apparatus as in claim 10, wherein two or more of the other isolation application instances are associated with chained micro-services that perform operations on the tagged traffic.

14. The apparatus as in claim 13, wherein the process when executed is further configured to:
share results of the operations between the two or more other isolation application instances.

15. The apparatus as in claim 14, wherein the apparatus determines the routing path for the traffic by:
computing a directed acyclic graph of isolation application instances for chained micro-services that perform operations on the tagged traffic.

16. The apparatus as in claim 10, wherein the traffic is tagged with Routing Protocol for Low-Power and Lossy Network (RPL) source routing information, the process when executed is further configured to:
forward, by one of the isolation application instances in the routing path, the traffic to a second node in the LAN using the RPL source routing information, wherein the forwarding isolation application instance is associated with the second node.

17. The apparatus as in claim 16, wherein the process when executed is further configured to:
instruct the one or more networking devices in the LAN to forward the traffic associated with the particular node to the second node via the LAN, instead of redirecting the traffic to the first isolation application instance.

18. The apparatus as in claim 10, wherein the process when executed is further configured to:
extract a query from the traffic associated with the particular node;
identify a second node in the LAN based on the query, wherein at least one isolation application instance in the determined routing path is associated with the identified second node.

19. A tangible, non-transitory, computer-readable medium storing program instructions that cause a service to execute a process comprising:
instructing, by the, one or more networking devices in a local area network (LAN) to form a virtual network overlay in the LAN that redirects traffic associated with a particular node in the LAN to a first isolation application instance hosted by the service;
receiving, at the first isolation application instance hosted by the service, the redirected traffic associated with the particular node;
determining, by the first isolation application instance hosted by the service, a routing path for the traffic that comprises one or more other isolation application instances hosted by the service;
tagging, by the first isolation application instance hosted by the service, the traffic to indicate the determined routing path; and
forwarding, by the first isolation application instance hosted by the service, the tagged traffic to a second isolation application instance along the determined routing path.

20. The computer-readable medium as in claim 19, wherein two or more of the other isolation application instances are associated with chained micro-services that perform operations on the tagged traffic, and wherein the process further comprises:
sharing, by the service, results of the operations between the two or more other isolation application instances
